(19) United States
(12) Patent Application Publication
(10) Pub. No.: US 2025/0187121 A1
(43) Pub. Date: Jun. 12, 2025

(54) Welding Flux for Precipitation Hardening Stainless Steel

(71) Applicant: NATIONAL PINGTUNG UNIVERSITY OF SCIENCE & TECHNOLOGY, Pingtung County (TW)

(72) Inventor: Kuang-Hung TSENG, Pingtung County (TW)

(21) Appl. No.: 18/777,613

(22) Filed: Jul. 19, 2024

(30) Foreign Application Priority Data
Dec. 12, 2023 (TW) 112148310

(51) Int. Cl. B23K 35/362

(52) U.S. Cl. CPC B23K 35/362

(57) ABSTRACT

A welding flux for precipitation hardening (PH) stainless steel comprises 20-25 wt % of silicon dioxide (SiO₂), 20-25 wt % of molybdenum trioxide (MoO₃), 20-25 wt % of chromium (III) oxide (Cr₂O₃), 15-20 wt % of nickel (III) oxide (Ni₂O₃), 4-8 wt % of aluminum oxide (Al₂O₃), 4-8 wt % of aluminum nitride (AlN), 4-8 wt % of nickel (II) oxide (NiO) and 4-6 wt % of copper (II) oxide (CuO). By the use of the welding flux for PH stainless steel, together with the tungsten inert gas welding (TIG welding) procedure, a weld bead with a weld D/W ratio greater than or equal to 0.8 can be formed between the two PH stainless steel workpieces. Therefore, the welding flux for PH stainless steel is suitable for single-pass, full penetration welding of the PH stainless steel workpiece with a thickness greater than or equal to 3 mm.

### CROSS REFERENCE TO RELATED APPLICATIONS

The application claims the benefit of Taiwan application serial No. 112148310, filed on Dec. 12, 2023, the subject matter of which are incorporated herein by reference.

### BACKGROUND OF THE INVENTION

### 1. Field of the Invention

The present invention generally relates to a welding flux and, more particularly, to a welding flux for precipitation hardening (PH) stainless steel.

### 2. Description of the Related Art

In general, the precipitation hardening (PH) stainless steel with excellent mechanical strength, better wear resistance and good atmospheric corrosion resistance can be formed by adding additional elements such as copper (Cu), aluminum (Al), titanium (Ti), niobium (Nb) and molybdenum (Mo) to the iron-chromium-nickel stainless steel (Fe—Cr—Ni stainless steel), followed by a solution treatment and an aging treatment. The PH stainless steel can be widely used in golf club heads, gas turbine blades, oil pipeline valves and nuclear energy reaction components, etc.

Tungsten inert gas (TIG) welding is a high-quality arc welding process, and is mainly applied to join metals such as aluminum alloy, titanium alloy, stainless steel and nickel-based superalloy. The TIG welding procedure is carried out under a protective atmosphere of an inert gas (e.g. argon (Ar) gas, helium (He) gas or the mixture thereof), with an electric arc generated by a tungsten electrode as a welding heat source for melting the joint of two workpieces of PH stainless steel. A conventional welding rod can be applied to the joint of the two workpieces of PH stainless steel, such that the conventional welding rod is melted to form a molten pool at the joint of the two workpieces of PH stainless steel. The molten pool is then cooled to form a weld bead which tightly joins the two workpieces of PH stainless steel. However, since the power density of the heat source used in the TIG welding procedure is not high enough, the formed molten pool is wide and shallow, resulting in a resultant weld bead with insufficient depth when the TIG welding procedure is applied to join the two workpieces of PH stainless steel with thickness greater than or equal to 3 mm.

Referring to FIG. 1, to eliminate the problem of forming the wide, shallow molten pool, before joining two workpieces of PH stainless steel 91, 91′, a side 91 of a workpiece of PH stainless steel 9 and a side 91′ of another workpiece of PH stainless steel 9′ are first milled by a miller M to form bevel faces 92, 92′, respectively. Referring to FIGS. 2 and 3, a groove is formed at the butt joint of the bevel faces 92, 92′ of the two workpieces of PH stainless steel 9, 9′ for carrying out the TIG welding procedure with the use of the conventional welding rod W, as well as the tungsten electrode E. A weld bead 93 is therefore formed after the TIG welding procedure. The formation of the bevel faces 92, 92′ increases the depth of the weld bead 93. However, the formation of the bevel faces 92, 92′ also increases the width of the weld bead 93 formed between the joined workpieces of PH stainless steel 9, 9′. Besides, a larger heat-affected zone (HAZ) is formed at the joint of the two workpieces of PH stainless steel 9, 9′, resulting in a decrease of mechanical strength of the jointed workpieces of PH stainless steel 9, 9′. Moreover, the larger HAZ also causes the problems such as severe thermal deformation, residual stress and even the decrease of the corrosion resistance. In addition, the formation of the bevel faces 92, 92′ also extends welding time and increases manufacturing costs.

In light of this, it is necessary to provide a welding flux for PH stainless steel.

### SUMMARY OF THE INVENTION

It is therefore an objective of the present invention to provide a welding flux for precipitation hardening (PH) stainless steel that can form a deep, narrow weld bead between two jointed workpieces, and thus, formation of a bevel faces of the two workpieces before the welding procedure can be omitted.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

As used herein, the term “a”, “an” or “one” for describing the number of the elements and members of the present invention is used for convenience, providing the general meaning of the scope of the present invention, and should be interpreted to include one or at least one. Furthermore, unless explicitly indicated otherwise, the concept of a single component also includes the case of plural components.

One embodiment of the present invention discloses a welding flux for precipitation hardening (PH) stainless steel. The welding flux can comprise: 20-25 wt % of silicon dioxide (SiO₂), 20-25 wt % of molybdenum trioxide (MoO₃), 20-25 wt % of chromium (III) oxide (Cr₂O₃), 15-20 wt % of nickel (III) oxide (Ni₂O₃), 4-8 wt % of aluminum oxide (Al₂O₃), 4-8 wt % of aluminum nitride (AlN), 4-8 wt % of nickel (II) oxide (NiO) and 4-6 wt % of copper (II) oxide (CuO).

Accordingly, when the welding flux for PH stainless steel with the specific weight percentages of SiO₂, MoO₃, Cr₂O₃, Ni₂O₃, Al₂O₃, AlN, NiO and CuO is applied to join two workpieces of PH stainless steel, a weld bead formed between the two joined workpieces has a higher weld depth/width ratio (D/W ratio). Therefore, risk of problems such as thermal deformation and residual stress can be reduced. Moreover, when the welding flux for PH stainless steel is applied to join the workpieces of PH stainless steel with thickness greater than or equal to 3 mm, the formation of the bevel faces of the two workpieces of PH stainless steel before the welding procedure can also be omitted, solving the problems of decrease of mechanical strength, as well as large heat-affected zone (HAZ). In addition, omitting the formation of the bevel faces of the two workpieces of PH stainless steel can also reduce welding time and manufacturing costs.

In the welding flux for PH stainless steel, the welding flux for PH stainless steel can comprise a plurality of powdered particles each having an average diameter of 50-90 μm. Thus, the welding flux for PH stainless steel can be a homogeneous mixture with great uniformity. As such, the welding flux for PH stainless steel can be easily spread on surface of the two workpieces of PH stainless steel. Also, during the tungsten inert gas (TIG) welding procedure, the welding flux for PH stainless steel can be easily melted by a welding heat source, and the depth of the resultant weld bead can therefore be increased.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 depicts pre-processing on a workpiece to be joined with another workpiece by the TIG welding procedure.

FIG. 2 depicts a cross-sectional view of two workpieces being joined by the TIG welding procedure.

FIG. 3 depicts a cross-sectional view of a weld bead formed between the two jointed workpieces.

FIG. 4 depicts a schematic diagram showing a welding flux for precipitation hardening (PH) stainless steel according to the present invention spreading on surfaces of workpieces of PH stainless steel to be joined by the TIG welding procedure.

FIG. 5 depicts a schematic diagram showing two jointed workpieces formed by the TIG welding procedure.

FIG. 6 depicts a cross-sectional view of two jointed workpieces of group B00 by TIG welding procedure without any welding fluxes. The weld bead of the two jointed workpieces of group B00 is dashed circle, the symbol D indicates the depth, and the symbol W indicates the width.

FIG. 7 depicts a cross-sectional view of two jointed workpieces of group B04 by the TIG welding procedure utilizing the welding flux of group A04. The weld bead of the two jointed workpieces of group B04 is dashed circle, the symbol D indicates the depth, and the symbol W indicates the width.

FIG. 8 depicts a cross-sectional view of two jointed workpieces of group B07 by the TIG welding procedure utilizing the welding flux of group A047. The weld bead of the two jointed workpieces of group B07 is dashed circle, the symbol D indicates the depth, and the symbol W indicates the width.

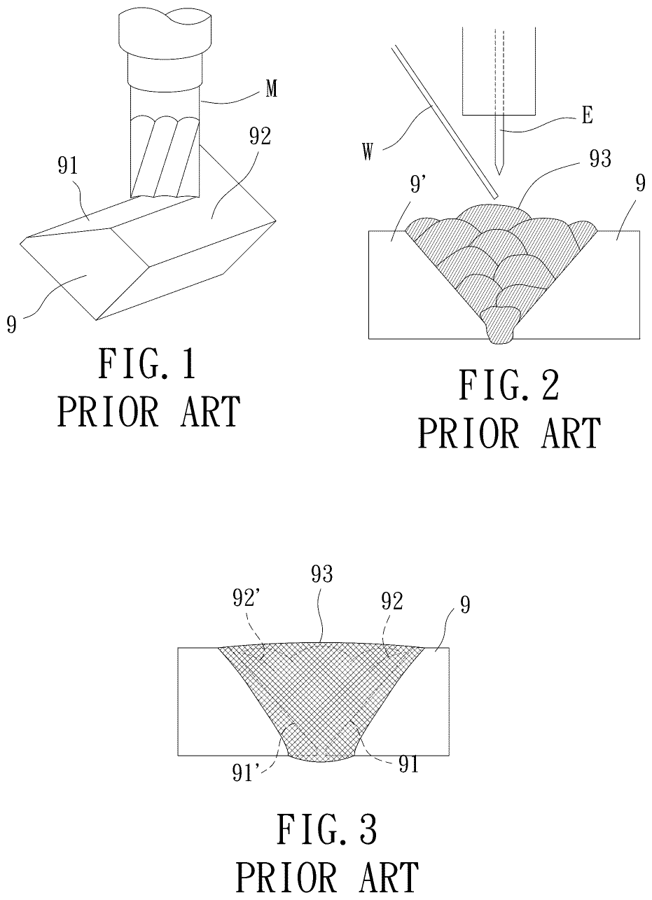

### DETAILED DESCRIPTION OF THE INVENTION

As used herein, the precipitation hardening (PH) stainless steel can be, but not limited to, the PH stainless steel such as UNS S17400, UNS S17700 and UNS S66286, which can be appreciated by a person having ordinary skill in the art.

The welding flux for PH stainless steel according to an embodiment of the present invention can comprise silicon dioxide (SiO₂), molybdenum trioxide (MoO₃), chromium (III) oxide (Cr₂O₃), nickel (III) oxide (Ni₂O₃), aluminum oxide (Al₂O₃), aluminum nitride (AlN), nickel (II) oxide (NiO) and copper (II) oxide (CuO). The welding flux for PH stainless steel can be used with the tungsten inert gas (TIG) welding procedure to join the workpieces of PH stainless steel with a thickness greater than or equal to 3 mm.

Specifically, the welding flux for PH stainless steel can comprise 20-25 wt % of SiO₂, 20-25 wt % of MoO₃, 20-25 wt % of Cr₂O₃, 15-20 wt % of Ni₂O₃, 4-8 wt % of Al₂O₃, 4-8 wt % of AlN, 4-8 wt % of NiO and 4-6 wt % of CuO. With such performance, when the TIG welding procedure is carried out with the welding flux for PH stainless steel, the weld bead formed between the two workpieces of PH stainless steel has a higher weld depth/width ratio (D/W ratio) greater than or equal to 0.8. Moreover, heat-affected zone (HAZ) formed between the two workpieces of PH stainless steel is reduced, decreasing the risk of thermal deformation and residual stress of the two jointed workpieces.

Moreover, the welding flux for PH stainless steel can comprise a plurality of powdered particles each having an average diameter of 50-90 μm. Thus, the welding flux for PH stainless steel can be a homogeneous mixture with great uniformity. As such, the welding flux for PH stainless steel can be easily spread on surface of the two workpieces of PH stainless steel. Also, during the tungsten inert gas (TIG) welding procedure, the welding flux for PH stainless steel can be easily melted by a welding heat source, and the depth of the resultant weld bead can therefore be increased.

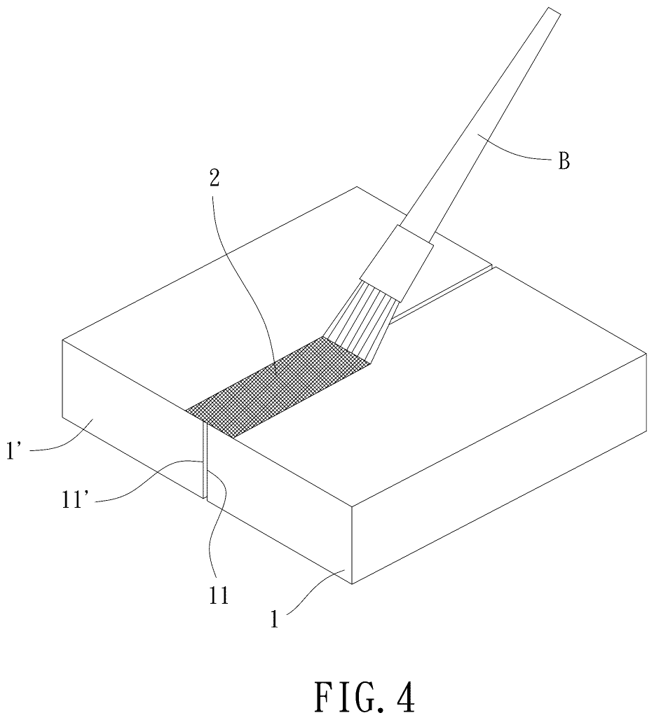

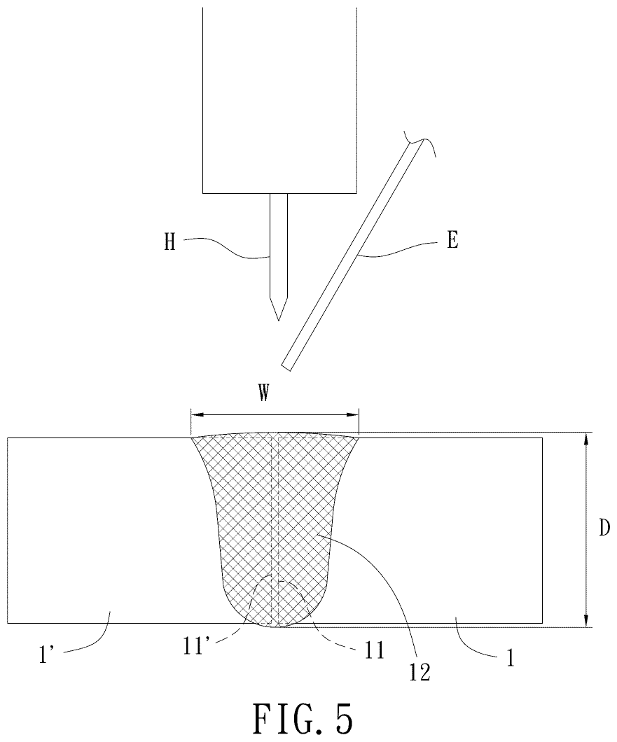

Referring to FIG. 4, before carrying out the TIG welding procedure, the respective sides 11, 11′ of two workpieces of PH stainless steel 1, 1′ can be abutted with each other, and the welding flux for PH stainless steel 2 can be applied by a brush B on the surface of the two workpieces of PH stainless steel 1, 1′. The TIG welding procedure can be carried out afterwards. Referring to FIG. 5, the welding flux for PH stainless steel is melted by a welding heat source H together with a tungsten electrode E to form a molten pool between sides 11, 11′ of the two workpieces of PH stainless steel 1, 1′. The molten pool is then cooled to form a weld bead 12, obtaining the two jointed workpieces. As shown in FIG. 5, a deep, narrow weld bead 12 with a higher weld D/W ratio is formed due to the use of the welding flux for PH stainless steel.

To validate whether the weld bead with a higher weld D/W ratio can be formed between the two workpieces of PH stainless steel by the TIG welding procedure utilizing the welding flux for PH stainless steel of the present invention, the following trials are carried out.

### Trial (A).

After mixing 15 wt % of SiO₂, 30 wt % of MoO₃, 20 wt % of Cr₂O₃, 12 wt % of Ni₂O₃, 6 wt % of Al₂O₃, 6 wt % of AlN, 6 wt % of NiO and 5 wt % of CuO, the mixture is formed as a paste-like slurry by acetone, obtaining the welding flux for PH stainless steel of group A01. The welding fluxes for PH stainless steel of groups A02-A12 are prepared following the same procedure, and the weight percentage of SiO₂, MoO₃, Cr₂O₃, Ni₂O₃, Al₂O₃, AlN, NiO and CuO are shown in TABLE 1.

TABLE 1

| | Weight percentage (%) | | | | | | | |
|---|---|---|---|---|---|---|---|---|
| Group | SiO₂ | MoO₃ | Cr₂O₃ | Ni₂O₃ | Al₂O₃ | AlN | NiO | CuO |
| A01 | 15 | 30 | 20 | 12 | 6 | 6 | 6 | 5 |
| A02 | 17 | 25 | 27 | 13 | 4 | 5 | 4 | 5 |
| A03 | 20 | 18 | 18 | 22 | 6 | 6 | 6 | 4 |
| A04 | 21 | 18 | 20 | 13 | 8 | 8 | 6 | 6 |
| A05 | 18 | 19 | 19 | 14 | 8 | 8 | 8 | 6 |
| A06 | 21 | 21 | 21 | 18 | 5 | 5 | 5 | 4 |
| A07 | 20 | 20 | 25 | 15 | 5 | 5 | 5 | 5 |
| A08 | 25 | 22 | 21 | 16 | 4 | 4 | 4 | 4 |
| A09 | 20 | 20 | 20 | 20 | 5 | 5 | 5 | 5 |
| A10 | 30 | 16 | 21 | 21 | 6 | 2 | 2 | 2 |
| A11 | 28 | 18 | 17 | 23 | 4 | 4 | 3 | 3 |
| A12 | 19 | 17 | 18 | 16 | 8 | 8 | 8 | 6 |

### Trial (B)

In this trial, two plates of PH stainless steel (UNS S17400) with thickness of 7 mm are used as the two workpieces of PH stainless steel 1, 1′. After removing contaminants attached on the surface of the two plates of PH stainless steel using a 240-grit silicon carbide (SiC) sandpaper, the two plates of PH stainless steel are swiped by acetone wipes.

Then, referring to FIG. 4, the paste-like slurries formed by the welding fluxes for PH stainless steel of groups A01-A12 are spread on the surface of the two workpieces of PH stainless steel 1, 1′ by the brush B. The TIG welding procedure is carried out after acetone is completely evaporated.

Referring to FIG. 5, the welding flux for PH stainless steel is melted by the welding heat source H together with the tungsten electrode E to form the molten pool between sides 11, 11′ of the two workpieces of PH stainless steel 1, 1′. The molten pool is then cooled to form the weld bead 12, obtaining the two jointed workpieces of groups B01-B12. In addition, the two jointed workpieces of group B00 is obtained by the TIG welding procedure without any welding fluxes.

During the TIG welding procedure, the welding current is set as 140 A, the welding speed is set as 50 mm/min, the flow rate of the shielding gas is set as 10 L/min, the tungsten electrode E is selected as EWLa-2 (φ 3.2 mm), the grinding angle of the tungsten electrode E is set as 60°, and the contact tip-to-work distance (that is, the distance between the tip of the tungsten electrode E and the surface of the two workpieces of PH stainless steel 1, 1′) is set as 1 mm.

After the TIG welding procedure, cross sections of the two jointed workpieces of groups B00-B12 are obtained. The depth D and the width W of the resultant weld bead 12 are also recorded, and the weld D/W ratio of groups B00-B12 is calculated. The depth D and the width W of the weld bead 12 of the two jointed workpieces of groups B0-B12, and the calculated weld D/W ratio of the weld bead 12 are recorded in TABLE 2.

TABLE 2

| | | | Weld D/W |
|---|---|---|---|
| Group | Depth D (mm) | Width W (mm) | Ratio |
| B00 | 2.77 | 11.13 | 0.25 |
| B01 | 4.25 | 11.48 | 0.37 |
| B02 | 4.78 | 11.43 | 0.42 |
| B03 | 5.15 | 11.41 | 0.45 |
| B04 | 5.74 | 10.30 | 0.56 |
| B05 | 6.84 | 9.92 | 0.69 |
| B06 | 7.98 | 9.72 | 0.82 |
| B07 | 8.57 | 9.14 | 0.94 |
| B08 | 8.85 | 9.71 | 0.91 |
| B09 | 7.90 | 9.78 | 0.81 |
| B10 | 7.54 | 10.65 | 0.71 |
| B11 | 6.93 | 10.78 | 0.64 |
| B12 | 5.01 | 11.40 | 0.44 |

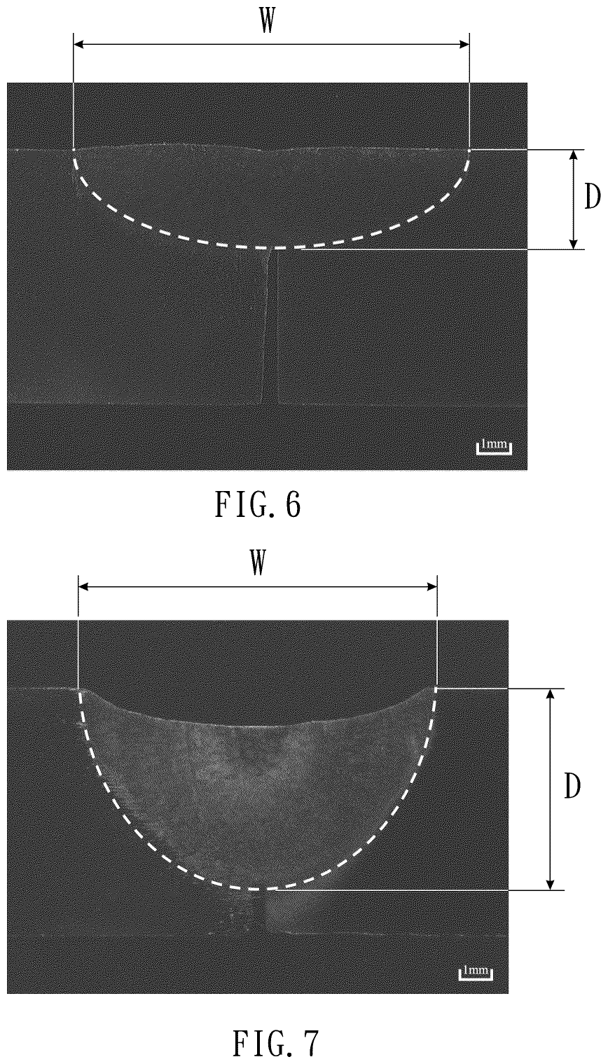

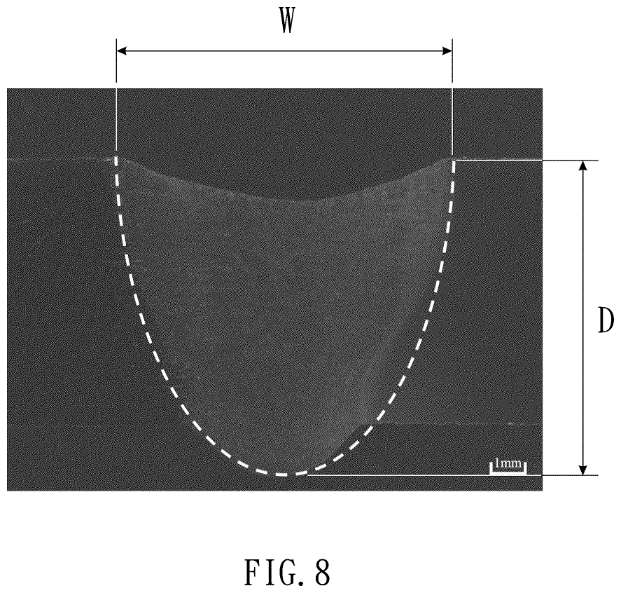

FIGS. 6-8 show the cross sections of the two jointed workpieces of groups B00, B04 and B17, respectively, and only the weld bead 12 of the two jointed workpieces of group B07 completely penetrates the two jointed workpieces. Moreover, referring to TABLE 2, compared to the weld bead 12 of the two jointed workpieces of groups B01-B05 and B10-B12, the weld bead 12 of the two jointed workpieces of groups B06-B09 has an increased depth D and a decreased width W. The weld D/W ratio of the weld bead 12 of the two jointed workpieces of groups B06-B09 is greater than or equal to 0.8, and even up to 0.94 (group B07). Thus, relative smaller HAZ can be formed, reducing the risk of problems such as thermal deformation and residual stress of the two jointed workpieces.

Accordingly, when the welding flux for PH stainless steel with the specific weight percentages of SiO₂, MoO₃, Cr₂O₃, Ni₂O₃, Al₂O₃, AlN, NiO and CuO is applied to join two workpieces of PH stainless steel, a weld bead formed between the two joined workpieces has a higher weld D/W ratio. Therefore, risk of problems such as thermal deformation and residual stress can be reduced. Moreover, when the welding flux for PH stainless steel is applied to join the workpieces of PH stainless steel with thickness greater than or equal to 3 mm, the formation of the bevel faces of the two workpieces of PH stainless steel before the welding procedure can also be omitted, solving the problems of decrease of mechanical strength, as well as large HAZ. In addition, omitting the formation of the bevel faces of the two workpieces of PH stainless steel can also reduce welding time and manufacturing costs.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A welding flux for precipitation hardening (PH) stainless steel, comprising: 20-25 wt % of silicon dioxide (SiO₂), 20-25 wt % of molybdenum trioxide (MoO₃), 20-25 wt % of chromium (III) oxide (Cr₂O₃), 15-20 wt % of nickel (III) oxide (Ni₂O₃), 4-8 wt % of aluminum oxide (Al₂O₃), 4-8 wt % of aluminum nitride (AlN), 4-8 wt % of nickel (II) oxide (NiO) and 4-6 wt % of copper (II) oxide (CuO).

2. The welding flux for PH stainless steel as claimed as claim 1, wherein the welding flux for PH stainless steel comprises a plurality of powdered particles each having an average diameter of 50-90 μm.
